(19) United States
(12) Patent Application Publication
(10) Pub. No.: US 2015/0168996 A1
(43) Pub. Date: Jun. 18, 2015

(54) IN-EAR WEARABLE COMPUTER

(71) Applicant: UNITED SCIENCES, LLC, ATLANTA, GA (US)

(72) Inventors: WESS ERIC SHARPE, VININGS, GA (US); KAROL HATZILIAS, ATLANTA, GA (US)

(21) Appl. No.: 14/109,796

(22) Filed: Dec. 17, 2013

(51) Int. Cl. G06F 1/16; H04R 1/10; G05B 15/02; G06F 21/31; G06F 3/16; G06F 3/01; H04R 1/08

(52) U.S. Cl. CPC G06F 1/163; G06F 3/011; H04R 1/10; H04R 1/08; G06F 21/31; G06F 3/165; G05B 15/02; H04R 2420/07

(57) ABSTRACT

A wearable computer including an earpiece body manufactured from an image of a user's ear, the image created from a three dimensional (‘3D’) optical scan of a user's ear; one or more sensors configured to sense information regarding the user when the wearable computer is worn in the ear; a computer processor and memory operatively coupled to the computer processor; and a wearable computing module stored in memory, the wearable computing module comprising a module of automated computing machinery configured to receive the sensed information and invoke a wearable computing action in dependence upon the sensed information.

### BACKGROUND

Wearable computers, also known as body-borne computers are electronic devices that are worn by a user. This class of wearable technology has been developed for general or special purpose information technologies and media development. Wearable computers are especially useful for applications that require more complex computational support than just hardware coded logics.

One of the main features of a wearable computer is consistency. There is a constant interaction between the computer and user and often there is no need to turn the device on or off. Another feature of wearable computers is the ability to multi-task. It is not necessary for a user to stop what she is doing to use the wearable computer. Often wearable computers are augmented into many user actions. Such wearable computers can be incorporated by the user to act like a prosthetic. It can therefore be an extension of the user's mind and body.

### SUMMARY

A wearable computer including an earpiece body manufactured from an image of a user's ear, the image created from a three dimensional (‘3D’) optical scan of a user's ear; one or more sensors configured to sense information regarding the user when the wearable computer is worn in the ear; a computer processor and memory operatively coupled to the computer processor; and a wearable computing module stored in memory, the wearable computing module comprising a module of automated computing machinery configured to receive the sensed information and invoke a wearable computing action in dependence upon the sensed information.

### BRIEF DESCRIPTION OF THE DRAWINGS

FIG. 1 sets forth a network diagram of a system according to embodiments of the present invention.

FIG. 2 sets forth a system diagram according to embodiments of the present invention.

FIG. 3 sets forth a flow chart illustrating an example method of in-ear wearable computing.

FIG. 4 sets forth a flow chart illustrating another example method of in-ear wearable computing.

FIG. 5 sets forth a flow chart illustrating another example method of in-ear wearable computing.

FIG. 6 sets forth a flow chart illustrating another example method of in-ear wearable computing.

FIG. 7 sets forth a flow chart illustrating another example method of in-ear wearable computing.

FIG. 8 sets forth a flow chart illustrating another example method of in-ear wearable computing.

FIG. 9 sets forth a flow chart illustrating another example method of in-ear wearable computing.

FIG. 10 sets forth a flow chart illustrating another example method of in-ear wearable computing.

### DETAILED DESCRIPTION OF EXAMPLE EMBODIMENTS

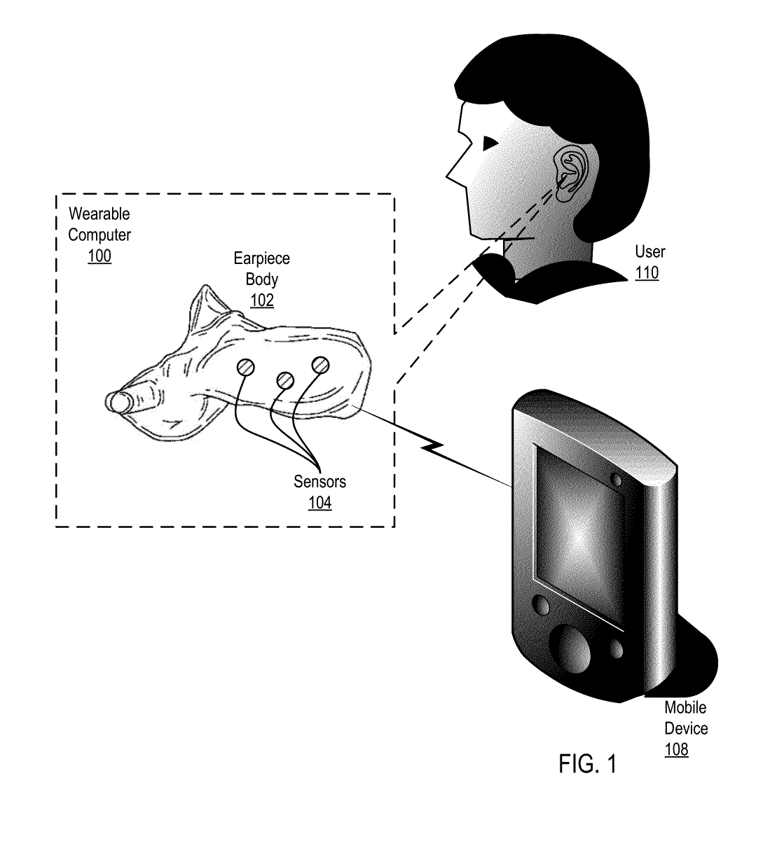

Example methods, wearable computers, apparatuses, and products for wearable computing in accordance with the present invention are described with reference to the accompanying drawings, beginning with FIG. 1. FIG. 1 sets forth a network diagram of a system according to embodiments of the present invention. The system of FIG. 1 includes a wearable computer (100) worn in a user's ear (110) and wirelessly connected to a mobile device (110). The example wearable computer (100) of FIG. 1 includes an earpiece body (102) manufactured from an image of a user's ear (110). Typically, such an image includes a three dimensional image (‘3D’) of the interior of the user's ear such as the ear canal. In some embodiments, portions of the exterior of the user's ear are also imaged. Such an image may be created from a three dimensional (‘3D’) optical scan of a user's ear (110). Creating a 3D image derived from a 3D optical scan of the interior of the patient's ear canal can be carried out using methods and systems described in U.S. patent application Ser. Nos. 13/417,649; 13/417,767, 13/586,471; 13/586,411; 13/586,459; 13/546,448; 13/586,448; 13/586,474; 14/040,973, 14/041,943; 14/049,666; 14/049,530; 14/049,687, all incorporated by reference herein in their entirety.

The wearable computer (100) of FIG. 1 also includes one or more sensors (104) configured to sense information regarding the user (110) when the wearable computer is worn in the ear. Such exemplary sensors are capable of sensing information including electroencephalography, electromyography, electrooculography, electrocardiography, accelerometry, reflective pulse oximetry, audio, temperature, and other sensed information about a user that may be gathered through the ear as will occur to those of skill in the art. Such sensed information is often used to derive biometric values for the user useful in wearable computing according to embodiments of the present invention such as pulse rate, body temperature, blood oxygen level, rapid eye movement sleep, non-rapid eye movement sleep, snoring, blood pressure, muscle tension, eye position, brain wave activity, and other values derived from sensed information as may occur to those of skill in the art.

The example wearable computer (100) of FIG. 1 also includes a computer processor and memory operatively coupled to the computer processor. The example wearable computer also includes a wearable computing module stored in memory, the wearable computing module comprising a module of automated computing machinery configured to receive the sensed information and invoke a wearable computing action in dependence upon the sensed information. Wearable computing actions include actions carried out for the benefit of the user wearing the wearable computer (100). In the example of FIG. 1, such actions may be carried out with the aid of wireless communications with and additional resources provided by the mobile computing device (108). Examples of wearable computing actions include authentication of the user, speech recognition, playing audio, playing the rendering of a text-to-speech engine, transmitting or recording biometric information for health and fitness, providing situational awareness to the user, allowing biometric interface actions such as invoking a speech interface or using eye movement or brain activity to control an application, playing music and entertainment, and many other wearable computing actions that will occur to those of skill in the art.

The mobile device (108) in the example of FIG. 1 is wirelessly coupled for data communications with the wearable computer (100). The mobile device (108) is itself also a computer capable of wirelessly providing additional resources for the wearable computing actions of the wearable computer (100). Such additional resources allow the user to experience the benefit of the additional computing power of the mobile device while still wearing a comfortable custom in-ear wearable computer.

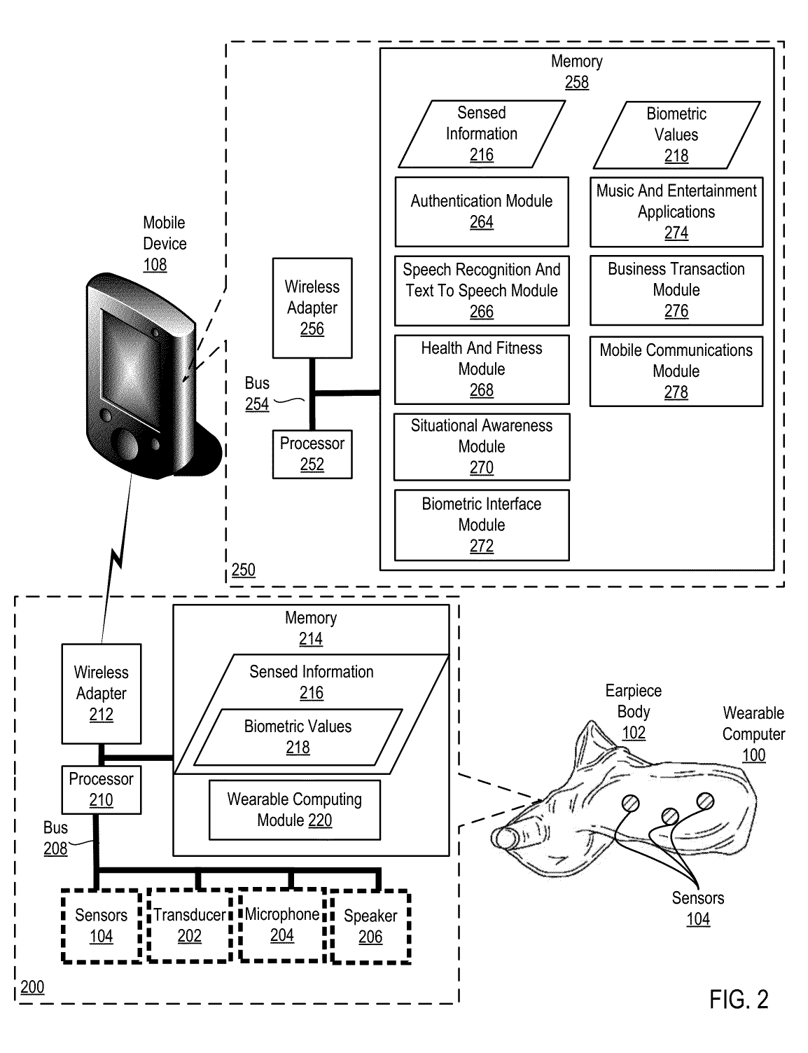

For further explanation, FIG. 2 sets forth a system diagram according to embodiments of the present invention. The system of FIG. 2 is similar to the system of FIG. 1 in that the system of FIG. 2 includes a wearable computer (100) wirelessly coupled for data communications with a mobile computing device (108).

The example wearable computer (100) of FIG. 2 includes an earpiece body (102) manufactured from an image of a user's ear. In the example of FIG. 2, the image created from a three dimensional (‘3D’) optical scan of a user's ear. The custom fit of the wearable computer of FIG. 1 provides a comfortable wearable computer that allows for hands and eyes free action by the user.

The example wearable computer (100) of FIG. 2 also includes one or more sensors (104) configured to sense information regarding the user when the wearable computer is worn in the ear. The sensors of the example wearable computer (100) sense information including electroencephalography, electromyography, electrooculography, electrocardiography, accelerometry, reflective pulse oximetry, audio, temperature, and other information that will occur to those of skill in the art. Such sensed information is often used to derive biometric values for the user useful in wearable computing according to embodiments of the present invention such as pulse rate, body temperature, blood oxygen level, rapid eye movement sleep, non-rapid eye movement sleep, snoring, blood pressure, muscle tension, eye position, brain wave activity, and other values derived from sensed information as may occur to those of skill in the art.

The example wearable computer (100) of FIG. 2 also includes one or more microphones (204). The example microphones (204) of FIG. 2 may include internal microphones for detecting audio from within the ear or external microphones for detecting audio from without the ear. Internal microphones may include microphones for detecting audio from speech from the user through either direct speech or through a bone conduction microphone or any other internal microphones that may occur to those of skill in the art. External microphones may be any microphone that usefully detects audio from without the ear such as ambient noise, external music, warning signals, or any other external audio that may occur to those of skill in the art. In various embodiments both internal and external microphones may be implemented as bone conducting microphones.

The example wearable computer (100) of FIG. 2 also includes one or more speakers (206). The example speakers of FIG. 2 may include traditional ear bud or earphone audio speakers, bone conduction, speakers or any other speakers that will occur to those of skill in the art. In some embodiments of the present invention, the speakers (206) the wearable computer (100) of FIG. 2 are implemented as one or more internal speaker oriented toward the tympanic membrane of the user in dependence upon the image created from the 3D scan. Such an image of the internal portion of the ear created from the 3D scan may provide the location and orientation of the tympanic membrane. Orienting speakers in dependence of such location or orientation provides improved quality and efficiency in audio presentation.

The example wearable computer (100) of FIG. 2 also includes a computer processor (210) and memory (214) and wireless adapter (212) operatively coupled to the computer processor (210) through bus (208). The example wearable computer (100) of FIG. 2 includes a wearable computing module (220) stored in memory (214), the wearable computing module (220) comprising a module of automated computing machinery configured to receive the sensed information (216) and invoke a wearable computing action in dependence upon the sensed information.

The wearable computer (100) of FIG. 2 includes one or more transducers (202). Such transducers may provide additional interaction with the user through various physical means such as vibration, pulsation, and other interaction provided by transducers that will occur to those of skill in the art.

In the example of FIG. 2, the wearable computer's (100) wearable computing module (220) includes a wireless communications module and is configured to transmit the sensed information wirelessly to a mobile computing device (108). In some embodiments, the sensed information is used to derive biometric values (218) in the wearable computer. Alternatively, the sensed information (216) is transmitted to the mobile device (108) and the sensed information is used to derive biometric values (218) by the mobile computing device. Such biometric values are useful in providing wearable computing actions as will occur to those of skill in the art.

In the example of FIG. 2, the wearable computer (100) also includes a wearable computing module (220) that includes a wireless communications module and is configured to transmit the sensed information (216) wirelessly to a mobile computing device (108) and receiving, from an authentication module (264) installed on the mobile computing device (108), authentication information regarding the user. The authentication module, in the example of FIG. 2, receives the sensed information either in its original form from the sensors and derives biometric values (218) or receives the sensed information as biometric values. The authentication module then authenticates the user based on the sensed information and returns to the wearable computer authentication information identifying whether the current wearer of the wearable computer is an authorized user of the wearable computer. A user may be authenticated by the quality of the fit of the wearable computer in the ear canal as detected by pressure, force or other sensors, the user may be authenticated by the way and shape the ear canal changes as the user's jaw moves, the user may be authenticated with voice recognition, through a speech password or any other manner of authentication that will occur to those of skill in the art.

In the example of FIG. 2, the wearable computer (100) includes a microphone (204) and a speaker (206), and the wearable computing module (220). In the example of FIG. 2, the wireless communications module is also configured to transmit sensed audio from the user to a speech recognition module (266) installed on a mobile computing device (108); receive, in response to the transmitted audio, an audio response; and play the audio response through the speaker (206). Through the use of speech recognition a user is allowed to remain hands-free and eyes-free and still communicate with applications available to that user through the in-ear wearable computer.

In the example of FIG. 2, the wearable computing module (220) is also configured to transmit the sensed information wirelessly to a mobile computing device (108); receive, from a health and fitness module (268) installed on the mobile computing device (108), health and fitness information regarding the user created in dependence upon biometric values (218) derived from the sensed information (216). Example health and fitness information may include heart rate, target heart rate, blood pressure, general information about the user's wellbeing, current body temperature of the user, brain wave activity of the user, or any other health and fitness information that will occur to those of skill in the art.

In the example of FIG. 2, the wearable computer (100) includes a microphone (204) and a plurality of speakers (206). In the example of FIG. 2, the speakers (206) include an internal speaker and the microphone (204) includes an external microphone. In the example of FIG. 2, the wearable computing module (220) includes a wireless communications module and is configured to transmit sensed audio from the external microphone to a situational awareness module (270) installed on a mobile computing device (108); receive, in response to the transmitted audio from the external microphone (204), an instruction to invoke the internal speaker (206); and play audio received through the external microphone (204) through the internal speaker (206). The situational awareness module (270) of FIG. 2 determines whether external sound should be passed through to the user. Such a situational awareness module may compare the external sound to a profile, a threshold, or other information to determine whether external sound should be played to the user.

In the example of FIG. 2, the wearable computing module (220) includes a wireless communications module and is configured to transmit the sensed information (216) to a biometric interface module (272) installed on a mobile computing device (108); and receive, in response to the sensed information, an instruction to invoke an biometric interface action in response to a user instruction determined from biometric values (218) derived from the sense information (216). The biometric interface module (272) allows a user to control applications through the use of biometrics derived from sensed information in the ear such as line of sight or eye movement, brainwave activity, or other biometrics that will occur to those of skill in the art.

In the example of FIG. 2, the wearable computer (100) includes an internal speaker and the wearable computing module (220) includes a wireless communications module and is configured to receive audio information from an entertainment application (274) installed on a mobile computing device (108) and playing audio through the internal speaker (206) in response to the received audio information.

In the example of FIG. 2, the wearable computer (100) includes a business transaction module (276) that provides business transaction applications such as applications for banking, commerce, and so on. In the example of FIG. 2, the wearable computer (100) includes a mobile communications module (278) that provides mobile communications with other mobile communications devices.

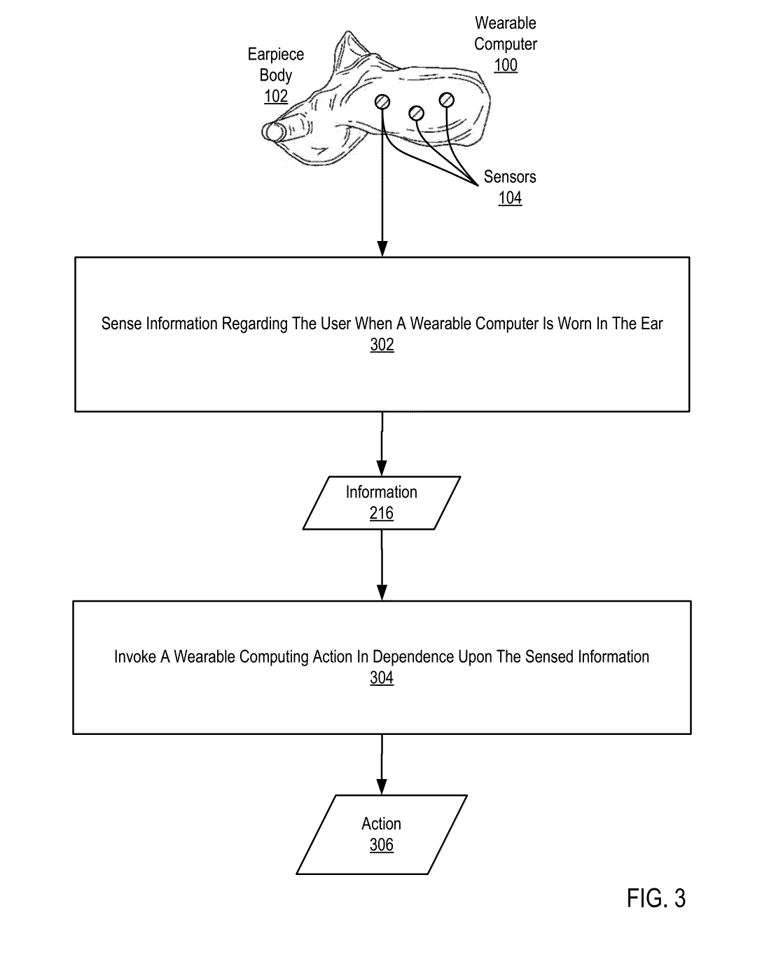

For further explanation, FIG. 3 sets forth a flow chart illustrating an example method of in-ear wearable computing. The method of FIG. 3 includes sensing (302), through sensors (104) integrated in an earpiece body (102) of a wearable computer (100), information (216) regarding the user when the wearable computer (100) is worn in the ear, the wearable computer (100) comprising the earpiece body (102) manufactured from an image of a user's ear, the image created from a three dimensional (‘3D’) optical scan of a user's ear. Sensing information according to the method of FIG. 3 may be carried out by electroencephalography, electromyography, electrooculography, electrocardiography, accelerometry, reflective pulse oximetry, sensing audio, sensing temperature, and sensing other information that will occur to those of skill in the art. Such sensed information is often used to derive biometric values for the user useful in wearable computing according to embodiments of the present invention such as pulse rate, body temperature, blood oxygen level, rapid eye movement sleep, non-rapid eye movement sleep, snoring, blood pressure, muscle tension, eye position, brain wave activity, and other values derived from sensed information as may occur to those of skill in the art.

The method of FIG. 3 also includes invoking (304) a wearable computing action (306) in dependence upon the sensed information. Wearable computing actions include actions carried out for the benefit of the user wearing the wearable computer (100). In the example of FIG. 1, such actions may be carried out with the aid of wireless communications with and additional resources provided by the mobile computing device (108). Examples of wearable computing actions include authentication of the user, speech recognition, playing audio, playing the rendering of a text-to-speech engine, transmitting or recording biometric information for health and fitness, providing situational awareness to the user, allowing biometric interface actions such as invoking a speech interface or using eye movement or brain activity to control an application, playing music and entertainment, and many other wearable computing actions that will occur to those of skill in the art.

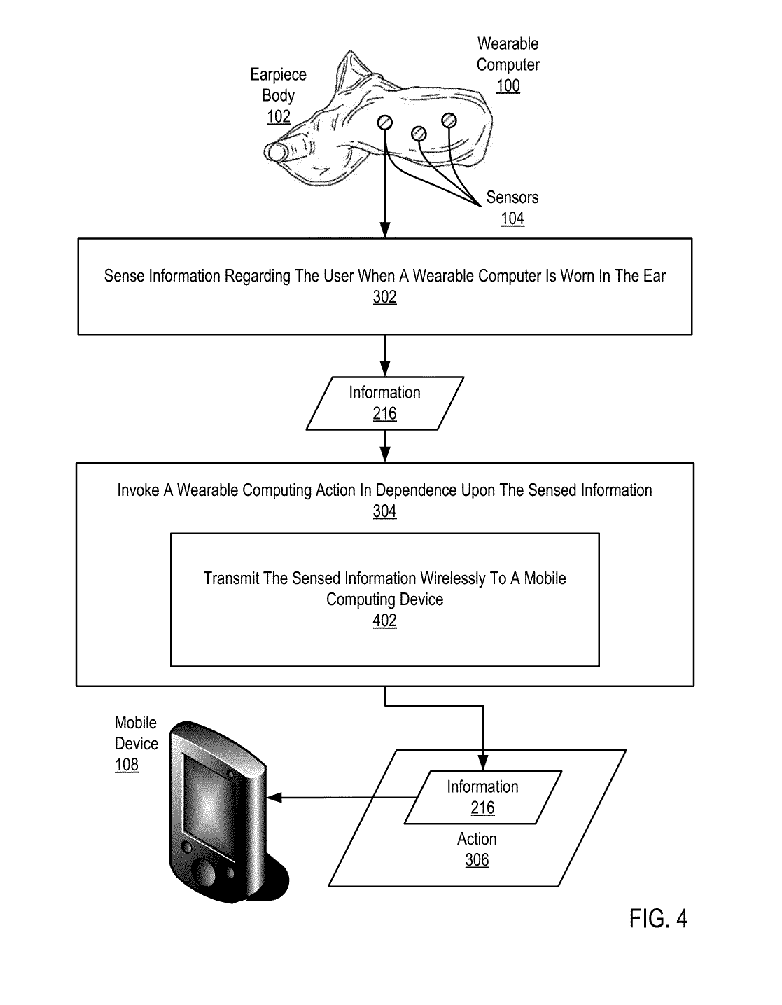

For further explanation, FIG. 4 sets forth a flow chart illustrating another example method of in-ear wearable computing. The method of FIG. 4 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information.

In the method of FIG. 4, however, invoking (304) a wearable computing action (306) also includes transmitting (402) the sensed information (216) wirelessly to a mobile computing device (108). Transmitting (402) the sensed information (216) wirelessly to a mobile computing device (108) may be carried out in some embodiments using Bluetooth. Bluetooth is a wireless technology standard for exchanging data over short distances (using short-wavelength microwave transmissions in the ISM band from 2400-2480 MHz) from fixed and mobile devices. Transmitting (402) the sensed information (216) wirelessly to a mobile computing device (108) may be carried out using other protocols and technologies such as TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art.

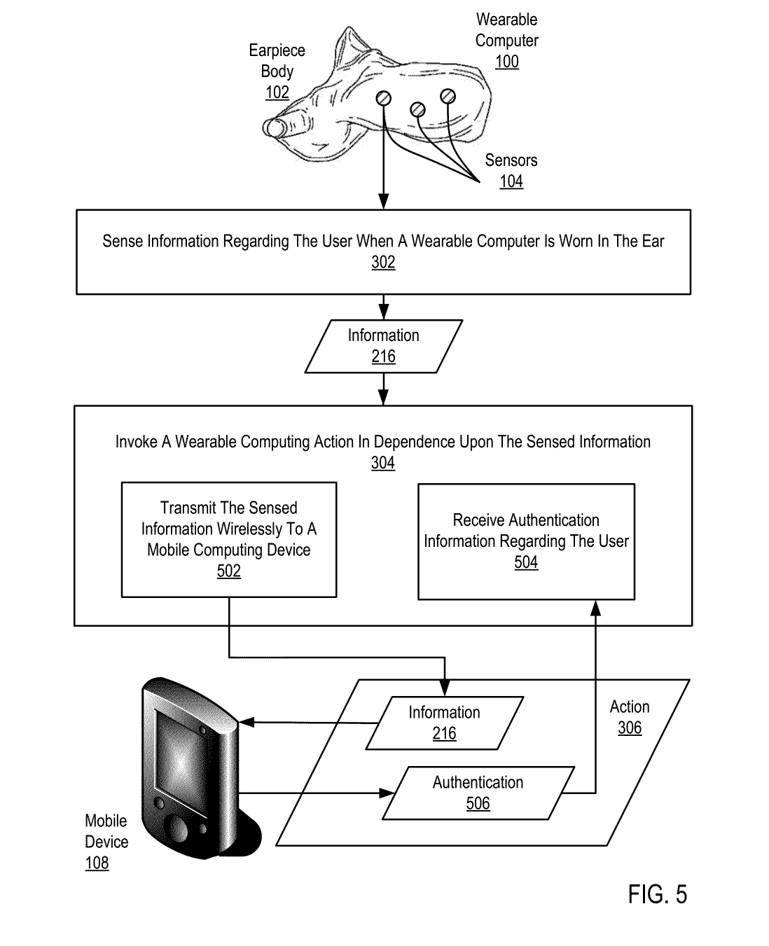

For further explanation, FIG. 5 sets forth a flow chart illustrating another example method of in-ear wearable computing. The method of FIG. 5 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 5, however, invoking (304) a wearable computing action (308) also includes transmitting (502) the sensed information wirelessly to a mobile computing device (108) and receiving (504), from an authentication module installed on the mobile computing device (108), authentication information (506) regarding the user.

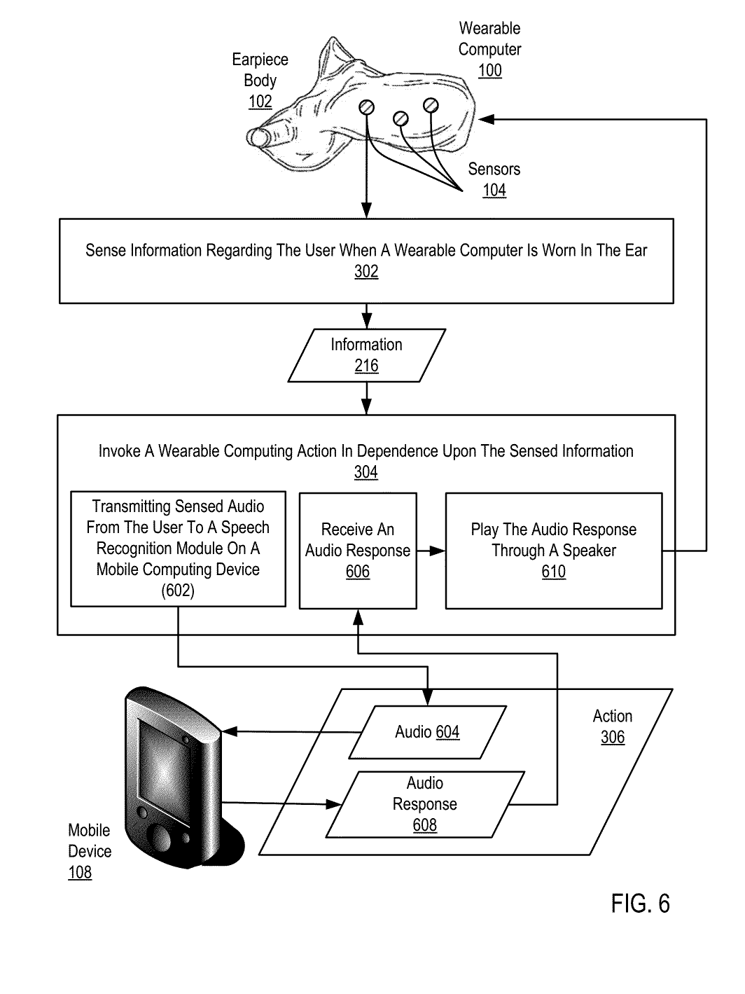

For further explanation, FIG. 6 sets forth a flow chart illustrating another example method of in-ear wearable computing. The method of FIG. 6 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 6, however, invoking (304) a wearable computing action (306) includes transmitting (602) sensed audio (604) from the user to a speech recognition module on a mobile computing device (108). Speech recognition (SR) is the translation of spoken words into text. It is also known as “automatic speech recognition”, “ASR”, “computer speech recognition”, “speech to text”, or just “STT”.

Some SR systems use “speaker independent speech recognition” while others use “training” where an individual speaker reads sections of text into the SR system. These systems analyze the person's specific voice and use it to fine tune the recognition of that person's speech, resulting in more accurate transcription. Systems that do not use training are called “speaker independent” systems. Systems that use training are called “speaker dependent” systems.

Speech recognition applications include voice user interfaces such as voice dialing (e.g. “Call home”), call routing (e.g. “I would like to make a collect call”), domestic appliance control, search (e.g. find a podcast where particular words were spoken), simple data entry (e.g., entering a credit card number), preparation of structured documents (e.g. a radiology report), speech-to-text processing (e.g., word processors or emails), and aircraft (usually termed Direct Voice Input).

The method of FIG. 6 also includes receiving (606), in response to the transmitted audio (604), an audio response (608) and playing (610) the audio response through a speaker in the wearable computer (100). Such an audio response may be streamed from the mobile device to the wearable computer.

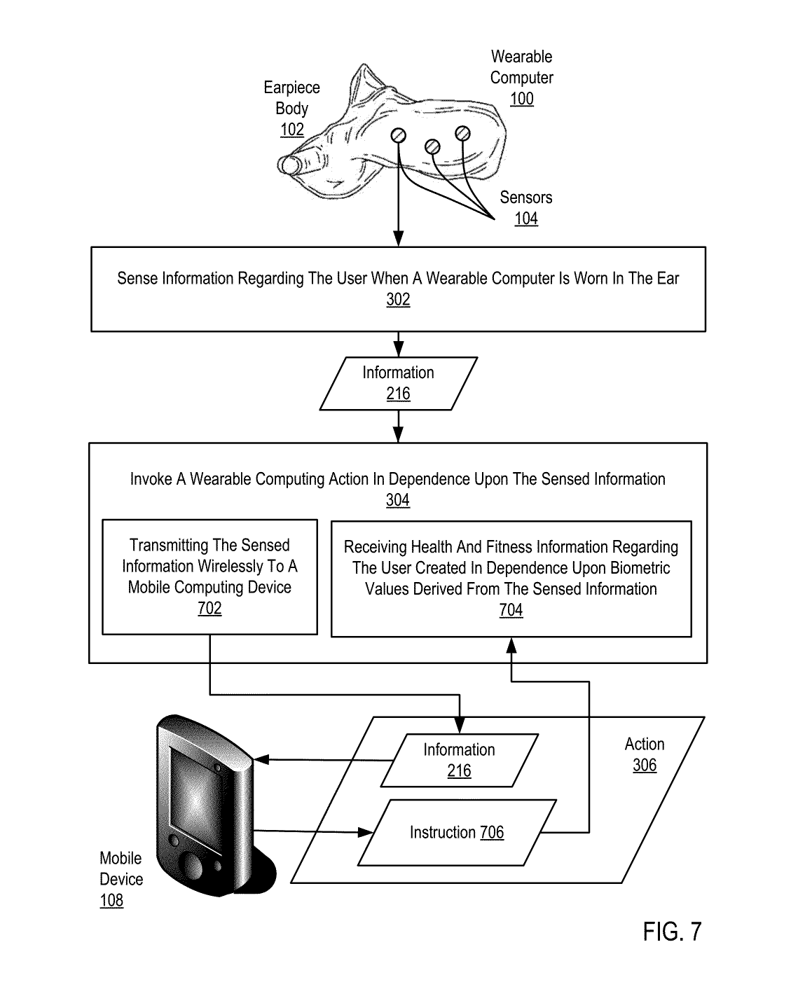

For further explanation, FIG. 7 sets forth a flow chart illustrating another example method of in-ear wearable computing. The method of FIG. 7 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 7, however, invoking (304) a wearable computing action (306) includes transmitting (702) the sensed information (216) wirelessly to a mobile computing device (108) and receiving (704), from a health and fitness module installed on the mobile computing device (108), health and fitness information regarding the user created in dependence upon biometric values derived from the sensed information (216). Example health and fitness information may include heart rate, target heart rate, blood pressure, general information about the user's wellbeing, current body temperature of the user, brain wave activity of the user, or any other health and fitness information that will occur to those of skill in the art.

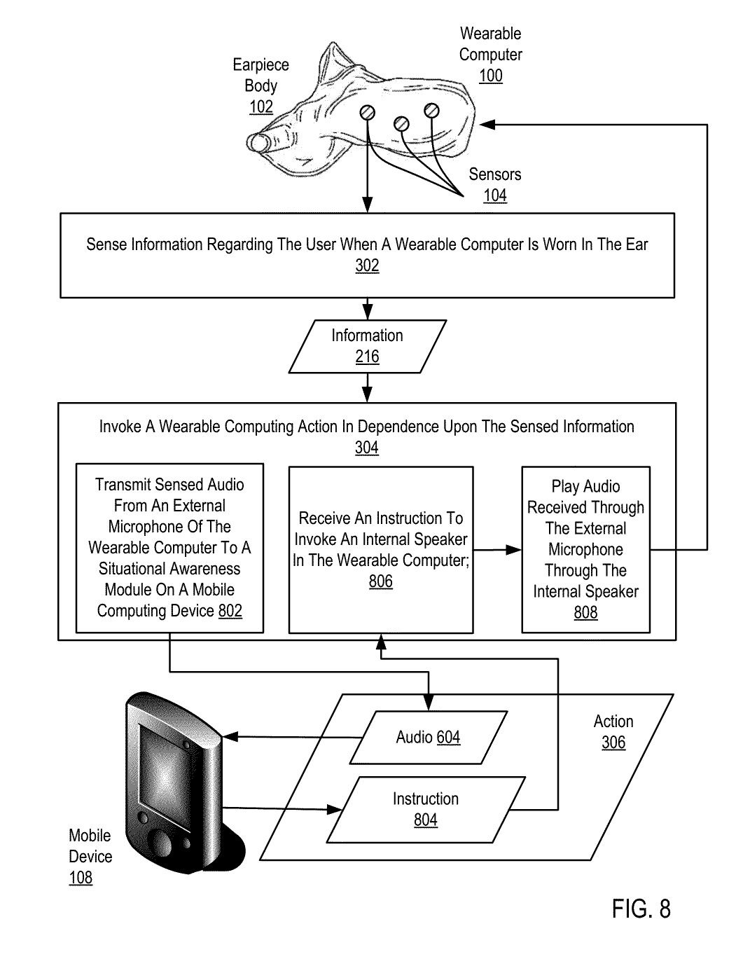

For further explanation, FIG. 8 sets forth a flow chart illustrating another example method of in-ear wearable computing. The method of FIG. 8 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 8, however, invoking (304) a wearable computing action (306) includes transmitting (802) sensed audio (604) from an external microphone of the wearable computer (100) to a situational awareness module on a mobile computing device (108) and receiving (806), in response to the transmitted audio (604) from the external microphone, an instruction (804) to invoke an internal speaker in the wearable computer (100). The situational awareness module determines whether external sound should be passed through to the user. Such a situational awareness module may compare the external sound to a profile, a threshold, or other information to determine whether external sound should be played to the user.

The method of FIG. 8 also includes playing (808) audio received through the external microphone through the internal speaker. Playing (808) audio received through the external microphone through the internal speaker may be carried out by passing sound detected by the external microphone to the internal speaker.

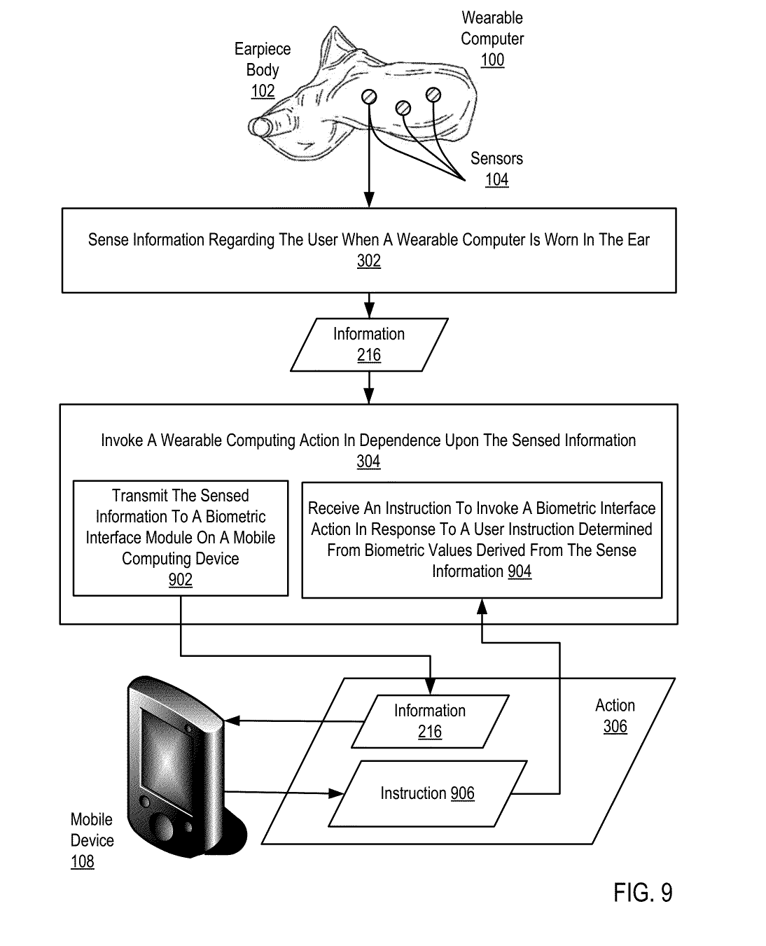

For further explanation, FIG. 9 sets forth a flow chart illustrating another example method of in-ear wearable computing. The method of FIG. 9 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 9, however, invoking (304) a wearable computing action (306) includes transmitting (902) the sensed information (216) to a biometric interface module on a mobile computing device (108) and receiving (904), in response to the sensed information (216) an instruction (906) to invoke a biometric interface action in response to a user instruction determined from biometric values derived from the sense information. The biometric interface module allows a user to control applications through the use of biometrics derived from sensed information in the ear such as line of sight or eye movement, brainwave activity, or other biometrics that will occur to those of skill in the art.

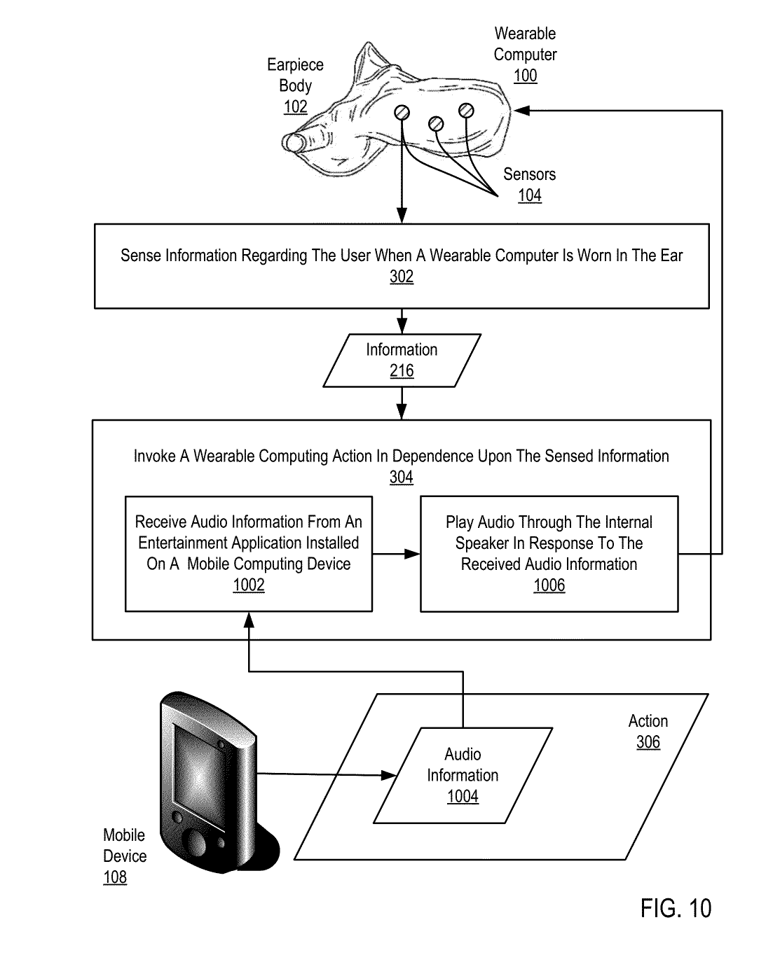

For further explanation, FIG. 10 sets forth a flow chart illustrating another example method of in-ear wearable computing. The method of FIG. 10 is similar to the method of FIG. 3 in that it includes sensing (302), through sensors (104) integrated in an earpiece body (102) of a wearable computer (100), information (216) regarding the user when the wearable computer (100) is worn in the ear and invoking (304) a wearable computing action (306) in dependence upon the sensed information. In the method of FIG. 10, however, invoking (304) a wearable computing action (306) includes receiving (1002) audio information from an entertainment application installed on a mobile computing device (108) and playing (1006) audio through the internal speaker in response to the received audio information (1004). Audio information from an entertainment application installed on a mobile computing device (108) may be music, speech-from-text, or any other audio information that will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A wearable computer, comprising:
an earpiece body manufactured from an image of a user's ear, the image created from a three dimensional (3D′) optical scan of the user's ear;
one or more sensors configured to sense information regarding the user when the wearable computer is worn in the ear;
a computer processor and memory operatively coupled to the computer processor; and
a wearable computing module stored in memory, the wearable computing module comprising a module of automated computing machinery configured to receive the sensed information and invoke a wearable computing action in dependence upon the sensed information.

2. The wearable computer of claim 1 wherein the wearable computing module further comprises a wireless communications module and the wearable computing action further comprises transmitting the sensed information wirelessly to a mobile computing device.

3. The wearable computer of claim 1 wherein the wearable computing module further comprises a wireless communications module and the wearable computing action further comprises transmitting the sensed information wirelessly to a mobile computing device and receiving, from an authentication module installed on the mobile computing device, authentication information regarding the user.

4. The wearable computer of claim 1 wherein the wearable computer further comprises a microphone and a speaker, and the wearable computing module further comprises a wireless communications module and the wearable computing action further comprises:
transmitting sensed audio from the user to a speech recognition module installed on a mobile computing device;
receiving, in response to the transmitted audio, an audio response; and
playing the audio response through the speaker.

5. The wearable computer of claim 1 wherein the wearable computing module further comprises a wireless communications module and the wearable computing action further comprises:
transmitting the sensed information wirelessly to a mobile computing device;
receiving, from a health and fitness module installed on the mobile computing device, health and fitness information regarding the user created in dependence upon biometric values derived from the sensed information.

6. The wearable computer of claim 1 wherein the wearable computer further comprises a microphone, an internal speaker, and an external microphone; and the wearable computing module further comprises a wireless communications module and the wearable computing action further comprises:
transmitting sensed audio from the external microphone to a situational awareness module on a mobile computing device;
receiving, in response to the transmitted audio from the external microphone, an instruction to invoke the internal speaker; and
playing audio received through the external microphone through the internal speaker.

7. The wearable computer of claim 1 wherein the wearable computing module further comprises a wireless communications module and the wearable computing action further comprises:
transmitting the sensed information to a biometric interface module installed on a mobile computing device;
receiving, in response to the sensed information, an instruction to invoke an biometric interface action in response to a user instruction determined from biometric values derived from the sense information.

8. The wearable computer of claim 1 wherein the wearable computer includes an internal speaker, the wearable computing module further comprises a wireless communications module, and the wearable computing action further comprises receiving audio information from an entertainment application installed on a mobile computing device and playing audio through the internal speaker in response to the received audio information.

9. A method of in-ear wearable computing, the method comprising:
sensing, through sensors integrated in an earpiece body of a wearable computer, information regarding the user when a wearable computer is worn in the ear, the wearable computer comprising the earpiece body manufactured from an image of a user's ear, the image created from a three dimensional (3D′) optical scan of the user's ear;
and invoking a wearable computing action in dependence upon the sensed information.

10. The method of claim 9 wherein invoking a wearable computing action further comprises transmitting the sensed information wirelessly to a mobile computing device.

11. The method of claim 9 wherein invoking a wearable computing action further comprises:
transmitting the sensed information wirelessly to a mobile computing device; and
receiving, from an authentication module installed on the mobile computing device, authentication information regarding the user.

12. The method of claim 9 wherein invoking a wearable computing action further comprises:
transmitting sensed audio from the user to a speech recognition module on a mobile computing device;
receiving, in response to the transmitted audio, an audio response; and
playing the audio response through a speaker in the wearable computer.

13. The method of claim 9 wherein invoking a wearable computing action further comprises:
transmitting the sensed information wirelessly to a mobile computing device; and
receiving, from a health and fitness module installed on the mobile computing device, health and fitness information regarding the user created in dependence upon biometric values derived from the sensed information.

14. The method of claim 9 wherein invoking a wearable computing action further comprises:
transmitting sensed audio from an external microphone of the wearable computer to a situational awareness module on a mobile computing device;
receiving, in response to the transmitted audio from the external microphone, an instruction to invoke an internal speaker in the wearable computer; and
playing audio received through the external microphone through the internal speaker.

15. The method of claim 9 wherein invoking a wearable computing action:
transmitting the sensed information to a biometric interface module on a mobile computing device; and
receiving, in response to the sensed information, an instruction to invoke a biometric interface action in response to a user instruction determined from biometric values derived from the sense information.

16. The method of claim 9 wherein invoking a wearable computing action further comprises:
receiving audio information from an entertainment application installed on a mobile computing device; and
playing audio through the internal speaker in response to the received audio information.

17. A wearable computer, comprising:
an earpiece body manufactured from an image of a user's ear, the image created from a three dimensional (3D′) optical scan of the user's ear;
one or more sensors configured to sense information regarding the user when the wearable computer is worn in the ear;
one or more microphones;
one or more speakers
a computer processor and memory operatively coupled to the computer processor; and
a wearable computing module stored in memory, the wearable computing module comprising a module of automated computing machinery configured to receive the sensed information and invoke a wearable computing action in dependence upon the sensed information.

18. The wearable computer of claim 17 wherein the one or more microphones comprise an internal microphone and an external microphone.

19. The wearable computer of claim 17 wherein the one or more microphones comprise an internal bone conducting microphone.

20. The wearable computer of claim 17 wherein the one or more speakers comprise an internal speaker oriented toward the tympanic membrane of the user in dependence upon the image created from the 3D scan.

21. The wearable computer of claim 17 wherein the speaker comprises an internal bone conducting speaker.

22. The wearable computer of claim 17 wherein one or more sensors are to sense information including electroencephalography, electromyography, electrooculography, electrocardiography, accelerometry, reflective pulse oximetry, audio, or temperature.
